(19) United States
(12) Patent Application Publication
(10) Pub. No.: US 2005/0117583 A1
(43) Pub. Date: Jun. 2, 2005

(54) Method and apparatus for receiving packets transmitted from transmission apparatus

(75) Inventors: Satoshi Uchida, Tachikawa-shi (JP); Takashi Wakutsu, Kawasaki-shi (JP); Takaaki Matsumoto, Yokohama-shi (JP)

Correspondence Address: Finnegan, Henderson, Farabow,;Garrett & Dunner, L.L.P., 1300 I Street, N.W., Washington, DC, 20005-3315, US

(73) Assignee: KABUSHIKI KAISHA TOSHIBA

(21) Appl. No.: 10/960,020

(22) Filed: Oct. 8, 2004

(30) Foreign Application Priority Data
Nov. 28, 2003 (JP) 2003-400795

(51) Int. Cl. H04L 12/28; H04L 12/56

(52) U.S. Cl. 370/395.4; 370/395.64; 370/235; 370/412

(57) ABSTRACT

An apparatus includes a reception unit which receives packets, to each of which a time stamp is added, sequentially transmitted from a transmission apparatus, a buffer which stores packets received by the reception unit, a timer which counts time, a unit which determines an output timing at which each packet stored in the buffer is output from the buffer, based on a value of a time stamp corresponding to each packet received by the reception unit and a value of the timer, a unit configured to adjust the output timing to holds a given data amount of packets in the buffer, based on a relationship between a data amount of packets stored in the buffer and a given threshold value, a unit which detects a transmission rate of packets, and a unit configured to change the threshold value based on the detected value of the transmission rate.

### CROSS-REFERENCE TO RELATED APPLICATIONS

This application is based upon and claims the benefit of priority from prior Japanese Patent Application No. 2003-400795, filed Nov. 28, 2003, the entire contents of which are incorporated herein by reference.

### BACKGROUND OF THE INVENTION

1. Field of the Invention

The present invention relates to a data reception apparatus which receives packets transmitted from a transmission apparatus and a data reception method used for the data reception apparatus.

2. Description of the Related Art

Recently, there has been developed a real-time transmission system for transmitting a digitally compression-encoded data stream such as digitally compression-encoded audio/video data in real time. The real-time transmission system transmits a data stream by using transmission packets such as MPEG2-TS packets (MPEG2-TS: MPEG2 transport streams).

Packets from the transmission apparatus are sent to the reception apparatus over a wired or wireless transmission path. In packet transmission in a network, packets differ in arrival times, that is, delay variations (packet delay variations) occur.

In order to absorb such packet delay variations, the reception apparatus uses a reception buffer for temporarily holding a predetermined amount of packets. Each received packet is temporarily stored in the reception buffer. The respective packets stored in the reception buffer are read out from the reception buffer to be sent to a decoder at a predetermined timing based on a clock of the reception apparatus side.

However, clocks of the transmission apparatus side and reception apparatus side are independent of each other. For this reason, when packet transmission from the transmission apparatus side to the reception apparatus side is continued for a predetermined period or more, overflow or underflow may occur in the reception buffer.

Jpn. Pat. Appln. KOKAI publication No. 2000-307638 discloses a reception buffer control apparatus having a function of dynamically changing the size (storage capacity) of a reception buffer as a technique of preventing overflow or underflow in the reception buffer.

Increasing the size of the reception buffer makes it more difficult to cause overflow or underflow. This, however, increases the transmission delay (buffer delay) caused when packets are stored in the reception buffer.

A reception buffer is required to absorb packet delay variations. However, a transmission delay amount originating from the reception buffer is a time lag between the reception of data and the actual playback of the data, and hence must be limited within a predetermined allowable range. If, therefore, the size of the reception buffer is simply increased, the transmission delay amount originating from the reception buffer will exceed the allowable range.

In a receiver for digital TV broadcast, for example, as the transmission delay amount originating from a reception buffer increases, responsiveness with respect to an operation such as switching the program to be viewed (channel switching) greatly deteriorates.

The transmission delay amount originating from the reception buffer is given by dividing the amount of data held in the reception buffer by the transmission rate (bit rate) of the data. For this reason, even if the same amount of data is held in the reception buffer, as the bit rate of data decreases, the transmission delay amount originating from the reception buffer, i.e., the time lag, increases.

It is necessary for a receiver for digital TV broadcast to receive broadcast programs with different bit rates, e.g., a high-bit-rate TV broadcast program conforming to the HD (High Definition) standards and a low-bit-rate broadcast program including only audio data.

It is therefore necessary to realize a new function of maintaining a transmission delay amount constant regardless of the bit rate of reception data.

### BRIEF SUMMARY OF THE INVENTION

According to an embodiment of the present invention, there is provided a data reception apparatus comprising data reception apparatus comprising a packet reception unit which receives packets, to each of which a time stamp is added, sequentially transmitted from a transmission apparatus, a buffer which stores packets received by the packet reception unit, a timer which counts time, a determining unit which determines an output timing at which each packet stored in the buffer is output from the buffer, based on a value of a time stamp corresponding to each packet received by the packet reception unit and a value of the timer, an output timing adjustment unit configured to adjust the output timing to holds a given data amount of packets in the buffer, based on a relationship between a data amount of packets stored in the buffer and a given threshold value, a transmission rate detecting unit which detects a transmission rate of packets received by the packet reception unit, and a control unit configured to change the threshold value based on the detected value of the transmission rate.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the arrangement of a data reception apparatus according to an embodiment of the present invention;

FIG. 2 is a view showing a time-stamped packet received by the data reception apparatus in FIG. 1;

FIG. 3 is a view showing how the time stamp and the packet received by the data reception apparatus in FIG. 1 are respectively stored in a time stamp detection unit and buffer;

FIG. 4 is a view for explaining output timing adjustment processing for packets which is executed by the data reception apparatus in FIG. 1;

FIG. 5 is a flowchart showing a sequence for threshold change processing executed by a control unit provided in the data reception apparatus in FIG. 1;

FIG. 6 is a block diagram showing another example of the arrangement of the data reception apparatus according to an embodiment of the present invention; and

FIG. 7 is a flowchart showing a sequence for threshold change processing executed by the control unit provided in the data reception apparatus in FIG. 6.

### DETAILED DESCRIPTION OF THE INVENTION

An embodiment of the present invention will be described below with reference to the views of the accompanying drawing.

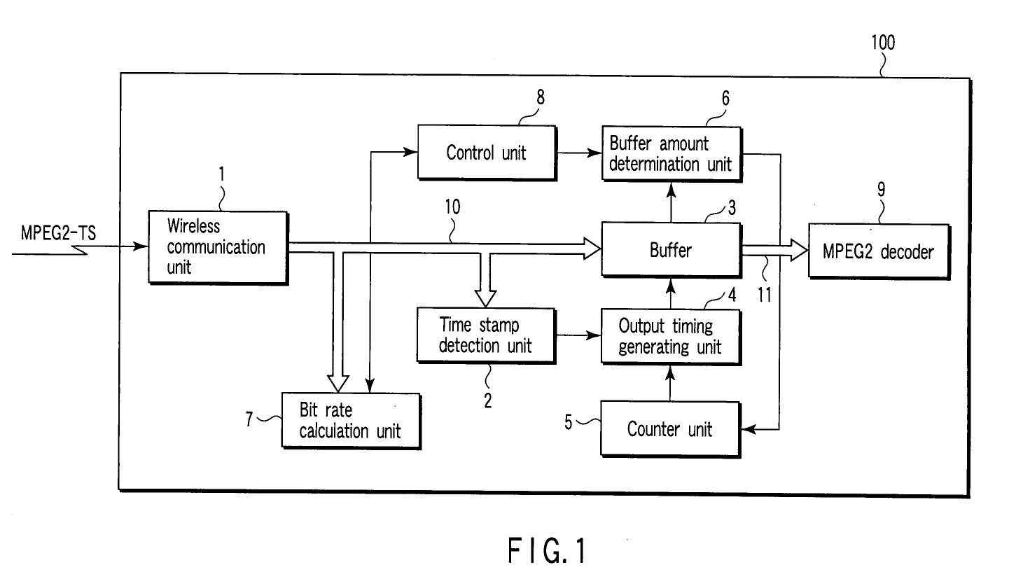

FIG. 1 shows the arrangement of a data reception apparatus according to the an embodiment of the present invention. A data reception apparatus 100 is a reception apparatus which is used in a real-time transmission system for transmitting a digitally compression-encoded data stream such as digitally compression-encoded audio/video data in real time. The data reception apparatus 100 functions as, for example, a receiver for digital TV broadcast.

As shown in FIG. 1, the data reception apparatus 100 includes a wireless communication unit 1, time stamp detection unit 2, buffer 3, output timing generating unit 4, counter unit 5, buffer amount determination unit 6, bit rate calculation unit 7, control unit 8, and MPEG2 (MPEG: Moving Picture Coding Experts Group) decoder 9.

The wireless communication unit 1 functions as a TV tuner which receives digital broadcast data. The wireless communication unit 1 is a packet reception apparatus which receives compression-encoded audio/video stream. The stream is sequentially transmitted as packets from a transmission apparatus at a broadcasting station by using broadcast signals. The wireless communication unit 1 demodulates the respective packets superimposed on the broadcast signals from the received broadcast signals. The wireless communication unit 1 then stores the demodulated packets in the buffer 3 via a data bus 10.

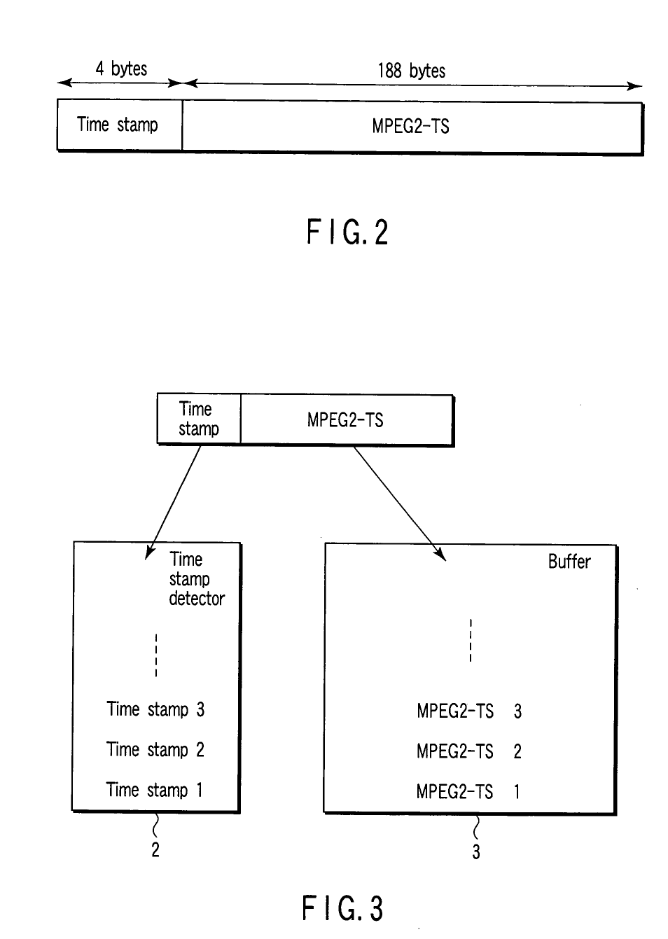

Each packet sent from the transmission apparatus to the wireless communication unit 1 is a time-stamped packet. As shown in FIG. 2, this time-stamped packet includes a 188-byte MPEG2-TS packet (MPEG2 transport stream packet) and a 4-byte time stamp added to the head of the packet. The data format shown in FIG. 2 is defined by the ARIB STD-B24 standard developed by ARIB (Association of Radio Industries and Businesses) which is a standard for the data broadcasting/coding scheme and transmission scheme used in digital broadcasting.

The time stamp added to each TS packet is the value of a 27-MHz clock counter on the transmission apparatus side, and is used as time information for controlling the relative input time of the TS packet following the time stamp to the MPEG2 decoder 9. In other words, the time stamp is related to a relative time interval between TS packets generated by the MPEG2 encoder of the transmission apparatus.

In packet transmission using radio signal, relatively large packet delay variations may occur due to communication control such as packet retransmission. When the amount of packet delay variation exceeds a certain amount, a problem may occur in the decoding operation of the MPEG2 decoder 9.

In order to absorb packet delay variations and replicate the transmission time intervals of TS packets transmitted from the transmission apparatus, the data reception apparatus 100 controls the output timing of each TS packet from the buffer 3 to the MPEG2 decoder 9.

The buffer 3 is a reception buffer which temporarily holds the TS packets received by the wireless communication unit 1. The buffer 3 is used as a smoothing buffer for absorbing packet delay variations and absorb the clock differences between the transmission apparatus and the data reception apparatus 100. The buffer 3 is formed from a FIFO (First-In First-Out) buffer. Data are read out from this buffer 3 in order in which they are written.

The time stamp detection unit 2 extracts a time stamp portion from each time-stamped TS packet, and stores it in a local buffer in the time stamp detection unit 2. As shown in FIG. 3, each time-stamped TS packet is separated into a time stamp portion and TS packet portion. The TS packet portions are sequentially written in the buffer 3 from its start position. The time stamp portions are sequentially written in the local buffer in the time stamp detection unit 2 from its start position. The local buffer in the time stamp detection unit 2 is also formed from a FIFO buffer.

In order to replicate the transmission time intervals between the TS packets transmitted from the transmission apparatus, the output timing generating unit 4 determines output timing at which each TS packet stored in the buffer 3 is output from the buffer 3 to the MPEG2 decoder 9. The output timing of each TS packet is determined on the basis of the value of the time stamp added to each TS packet and the counter value of the counter unit 5.

More specifically, the output timing generating unit 4 reads out a time stamp corresponding to each TS packet stored in the buffer 3 from the local buffer in the time stamp detection unit 2. The output timing generating unit 4 then compares the readout time stamp with the counter value of the counter unit 5. If the counter value of the counter unit 5 coincides with the value of the time stamp, the output timing generating unit 4 reads out a TS packet corresponding to the time stamp coinciding with the counter value of the counter unit 5 from the buffer 3, and sends out the TS packet to the MPEG2 decoder 9 via a data bus 11. In this manner, the output timing of each TS packet stored in the buffer 3, i.e., the relative input time of each TS packet to the MPEG2 decoder 9, is controlled by the value of the time stamp added to the TS packet. This makes it possible to read out TS packets from the buffer 3 at the same intervals as those at which the transmission apparatus encodes the TS packets.

Note that both a time stamp and a TS packet may be stored together in the buffer 3 without being separated from each other. In this case, the output timing of each TS packet can be controlled by reading out the value of the time stamp of each time-stamped TS packet stored in the buffer 3 from the buffer 3 and comparing it with the counter value of the counter unit 5.

The counter unit 5 is a timer for counting time. The counter unit 5 is formed from a 27-MHz free-running counter independent of a clock (timer) on the transmission apparatus side.

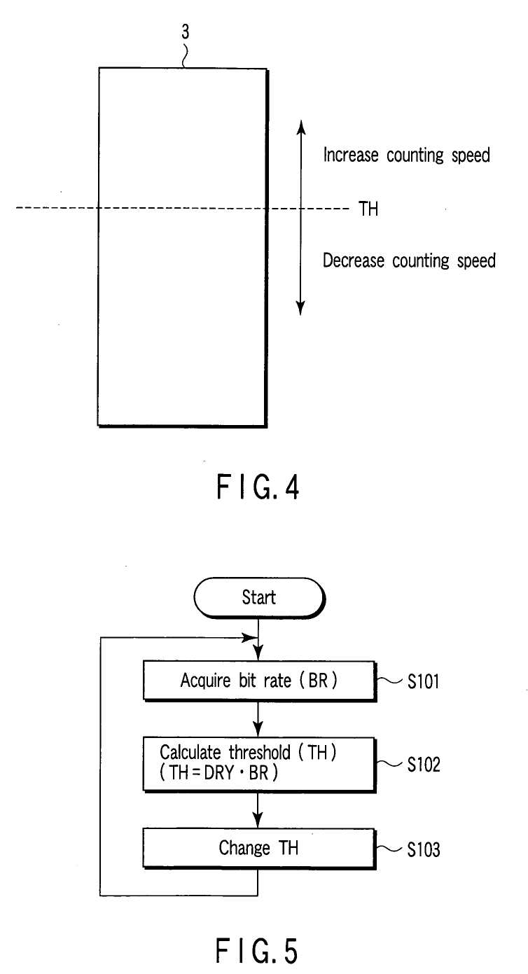

On the basis of the relationship between the data amount of TS packets stored in the buffer 3 and a pre-designated threshold TH, the buffer amount determination unit 6 adjusts the output timing of each TS packet from the buffer 3 so as to always hold packets equal in data amount to the threshold TH in the buffer 3. The value of the threshold TH is set in the buffer amount determination unit 6 by the control unit 8. As shown in FIG. 4, the buffer amount determination unit 6 performs the following operations:

(1) increases the counting speed of the counter unit 5 if the data amount of TS packets stored in the buffer 3 exceeds the threshold TH, and

(2) decreases the counting speed of the counter unit 5 if the data amount of TS packets stored in the buffer 3 is less than the threshold TH.

This output timing adjustment processing is performed to absorb the frequency difference between a 27-MHz clock forming a time stamp on the transmission apparatus side and a 27-MHz clock for the counter unit 5 of the data reception apparatus 100. More specifically, if the clock frequency of the transmission apparatus is higher than that of the counter unit 5, the buffer 3 tends to overflow. As a result, the data amount of TS packets stored in the buffer 3 exceeds the threshold TH. In contrast, if the clock frequency of the transmission apparatus is lower than that of the counter unit 5, the buffer 3 tends to underflow. As a result, the data amount of TS packets stored in the buffer 3 becomes smaller than the threshold TH.

When the data amount of TS packets stored in the buffer 3 exceeds the threshold TH, the output timing is accelerated by the above output timing adjustment processing. When the data amount of TS packets stored in the buffer 3 becomes smaller than the threshold TH, the output timing is decelerated by the processing. This makes it possible to absorb the clock difference between the transmitting side and the receiving side and prevent overflow and underflow in the buffer 3

Note that output timing adjustment may be performed by increasing/decreasing the value of each time stamp stored in the buffer 3 in the time stamp detection unit 2 on the basis of the magnitude relationship between the data amount of TS packets stored in the buffer 3 and the threshold TH instead of controlling the counting operation of the counter unit 5. In this case as well, the output timing can be adjusted.

The bit rate calculation unit 7 is a detector which detects the transmission rate (bit rate BR) of time-stamped TS packets received by the wireless communication unit 1. In order to detect the bit rate BR of time-stamped TS packets received by the wireless communication unit 1, the bit rate calculation unit 7 monitors the data output from the wireless communication unit 1 to the data bus 10 and detects the number of time-stamped TS packets received by the wireless communication unit 1 per unit time or the amount of data (the number of bytes) received by the wireless communication unit 1.

If the transmission apparatus has a function of transmitting bit rate information indicating the bit rate of time-stamped TS packets, the bit rate information is superimposed on a broadcast signal for transmitting the packets; the bit rate calculation unit 7 may detect the bit rate of TS packets from the bit rate information.

The control unit 8 is a processor which controls the operation of the data reception apparatus 100. The control unit 8 reads the value of the bit rate BR detected by the bit rate calculation unit 7, and change the value of the threshold TH set in the buffer amount determination unit 6 on the basis of the value of the bit rate BR. Although the default value of the threshold TH set in the buffer amount determination unit 6 is determined in advance, the value of the threshold TH set in the buffer amount determination unit 6 is dynamically changed in accordance with the value of the bit rate BR of data received by the data reception apparatus 100.

The value of the threshold TH is changed to keep the transmission delay amount due to the storage of TS packets in the buffer 3 constant regardless of the value of the bit rate BR of TS packets received.

The MPEG2 decoder 9 decodes compression-encoded data contained in the payload of a TS packet.

A sequence for threshold change processing executed by the control unit 8 will be described below with reference to the flowchart of FIG. 5.

During the reception period of time-stamped TS packet, the control unit 8 periodically reads the value of the bit rate BR from the bit rate calculation unit 7 by polling (step S101). The control unit 8 then calculates the threshold TH to be set in the buffer amount determination unit 6 on the basis of the read value of the bit rate BR (step S102). The threshold TH is calculated by
TH(bit)=DLY(sec)×BR(bit/sec) (1)
where DLY is the allowable transmission delay time. The value of DLY is defined in advance to smoothly perform operation such as switching the program to watch (channel switching).

The control unit 8 changes the value of the threshold TH set in the buffer amount determination unit 6 to the value calculated in step S102 (step S103). Changing the threshold TH in this manner makes it possible to keep a transmission delay constant regardless of the value of a bit rate. Therefore, for example, in either of the cases where a high-bit-rate broadcast program such as a TV broadcast program conforming to HD (High Definition) standards and a low-bit-rate broadcast program containing only audio data are received and played back, the transmission delay amount due to the buffer 3 can be kept to the value defined by DLY without causing overflow and underflow in the buffer 3.

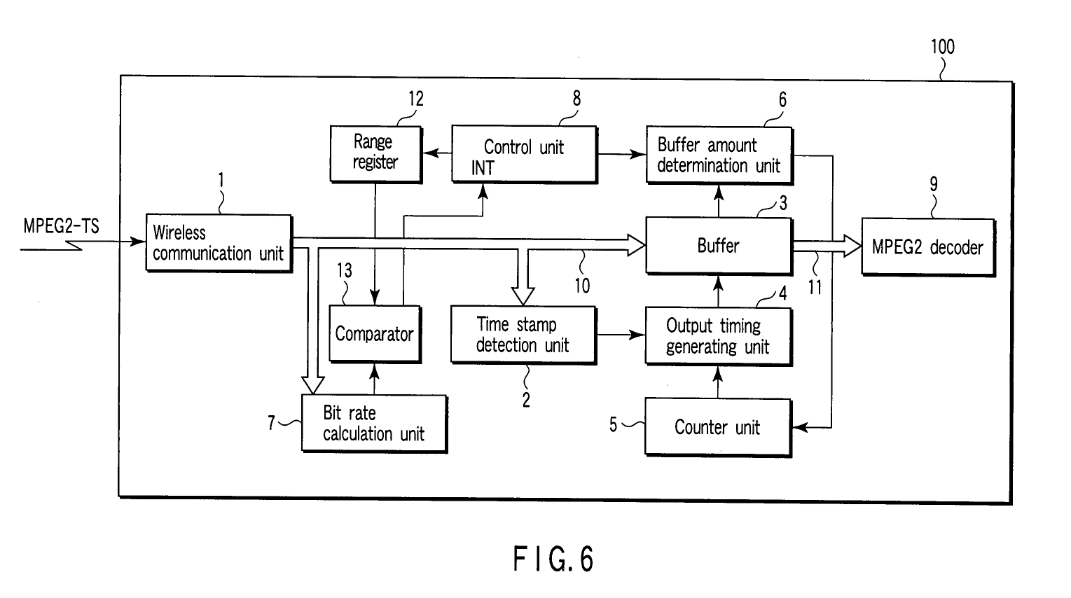

FIG. 6 shows another example of the arrangement of the data reception apparatus 100. The data reception apparatus 100 in FIG. 6 includes a range register 12 and comparator 13 in addition to the arrangement shown in FIG. 1.

The range register 12 holds an upper limit value and lower limit value which define a predetermined bit rate range. The upper and lower limit values are set in the range register 12 by the control unit 8. The comparator 13 functions as an interrupt signal generator which generates an interrupt signal INT to the control unit 8 when the value of the bit rate BR of time-stamped TS packets detected by the bit rate calculation unit 7 deviates from the predetermined bit rate range set in the range register 12.

The comparator 13 compares the value of the bit rate BR of time-stamped TS packets detected by the bit rate calculation unit 7 with each of the upper and lower limit values set in the range register 12. If the value of the bit rate BR exceeds the upper limit value or becomes smaller than the lower limit value, the comparator 13 generates the interrupt signal INT to notify the control unit 8 of the change in the value of the bit rate BR. The comparator 13 may be provided in the bit rate calculation unit 7.

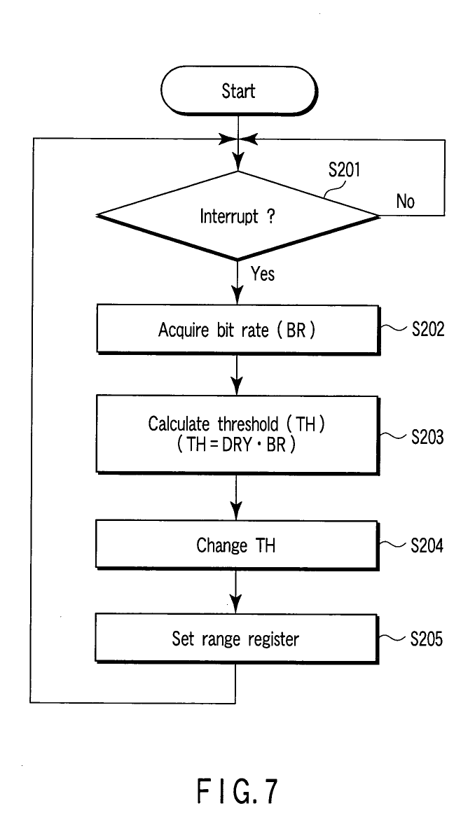

A sequence for processing executed by the control unit 8 in response to the interrupt signal INT will be described next with reference to the flowchart of FIG. 7.

Upon receiving an interrupt signal from the comparator 13 (YES in step S201), the control unit 8 acquires the current value of the bit rate BR from the bit rate calculation unit 7 (step S202). The control unit 8 calculates the threshold TH according to equation (1) on the basis of the acquired value of the bit rate BR (step S203).

The control unit 8 then changes the value of the threshold TH currently set in the buffer amount determination unit 6 to the value calculated in step S203 (step S204). Thereafter, the control unit 8 sets a new upper limit value and lower limit value in the range register 12 to place the current value of the bit rate BR between the new upper and lower limit values (step S205).

According to the arrangement of the data reception apparatus 100 in FIG. 6, the control unit 8 can change the value of the threshold TH in accordance with a change in the bit rate BR without polling the bit rate calculation unit 7.

As has been described above, in the data reception apparatus 100 according to this embodiment, the output timing when each packet stored in the buffer 3 is output from the buffer 3 to the MPEG2 decoder 9 is determined on the basis of the value of a time stamp corresponding to each received packet and the value of the counter unit (timer) 5. This output timing is automatically adjusted to hold a predetermined data amount of packets in the buffer 3 on the basis of the relationship between the data amount of packets stored in the buffer 3 and a predetermined threshold. This makes it possible to absorb the clock difference between the data reception apparatus 100 and the transmission apparatus and hence to prevent the occurrence of overflow and underflow in the buffer 3. In addition, the value of the threshold is automatically changed on the basis of the value of the transmission rate of packets. This can keep a transmission delay amount due to the storage of packets in the buffer 3 constant even if the bit rate of packets to be received changes.

Note that the arrangement of the data reception apparatus 100 can be applied to a reception apparatus for receiving a data stream such as digitally compression-encoded audio/video data transmitted through a wireless LAN, in addition to the digital broadcast program reception apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A data reception apparatus comprising:
a packet reception unit which receives packets, to each of which a time stamp is added, sequentially transmitted from a transmission apparatus;
a buffer which stores packets received by the packet reception unit;
a timer which counts time;
a determining unit which determines an output timing at which each packet stored in the buffer is output from the buffer, based on a value of a time stamp corresponding to each packet received by the packet reception unit and a value of the timer;
an output timing adjustment unit configured to adjust the output timing to holds a given data amount of packets in the buffer, based on a relationship between a data amount of packets stored in the buffer and a given threshold value;
a transmission rate detecting unit which detects a transmission rate of packets received by the packet reception unit; and
a control unit configured to change the threshold value based on the detected value of the transmission rate.

2. The apparatus according to claim 1, wherein the output timing adjustment unit is configured to advance the output timing if the data amount of packets stored in the buffer exceeds the threshold value, and delay the output timing if the data amount of packets stored in the buffer is smaller than the threshold value.

3. The apparatus according to claim 1, wherein the output timing adjustment unit increases a counting speed of the timer if the data amount of packets stored in the buffer exceeds the threshold value, and decreases the counting speed of the timer if the data amount of packets stored in the buffer is less than the threshold value.

4. The apparatus according to claim 1, wherein the transmission rate detecting unit is configured to detect the number of packets received by the packet reception unit per unit time to detect the transmission rate.

5. The apparatus according to claim 1, wherein the control unit includes a processor, and
the transmission rate detecting unit includes a detector which detects the number of packets received by the packet reception unit per unit time, and a interrupt signal generator which generates an interrupt signal to the processor when a value of a transmission rate detected by the detector deviates from a given transmission rate range.

6. The apparatus according to claim 1, wherein the transmission rate detecting unit is configured to detect the transmission rate of the packets from transmission rate information transmitted from the transmission apparatus.

7. The apparatus according to claim 1, wherein
each packet received by the packet reception unit includes compression-encoded digital broadcast program data, and
the packet reception unit includes a wireless communication unit which receives the packets transmitted from the transmission apparatus by a radio signal.

8. A method of receiving packets, to each of which a time stamp is added, sequentially transmitted from a transmission apparatus to a reception apparatus, the method comprising:
storing the received packets in a buffer of the reception apparatus;
determining an output timing at which each packet stored in the buffer is output from the buffer, based on a value of a time stamp corresponding to each of the received packets and a value of a timer provided in the reception apparatus;
adjusting the output timing to holds a given data amount of packets in the buffer, based on a relationship between a data amount of packets stored in the buffer and a given threshold value;
detecting a transmission rate of the received packets; and
changing the threshold value based on the detected value of the transmission rate.

9. The method according to claim 8, wherein the adjusting includes increasing a counting speed of the timer if the data amount of packets stored in the buffer exceeds the threshold value, and decreasing the counting speed of the timer if the data amount of packets stored in the buffer is less than the threshold value.

10. The method according to claim 8, wherein the detecting includes detecting the number of packets received per unit time to detect the transmission rate.

11. The method according to claim 8, wherein the detecting includes detecting the transmission rate from transmission rate information transmitted from the transmission apparatus.
